(19) United States
(12) Patent Application Publication
(10) Pub. No.: US 2026/0253515 A1
(43) Pub. Date: Aug. 27, 2026

(54) LABEL FOR PACKAGING

(71) Applicant: ETIVOET BV, Deinze (BE)

(72) Inventor: Philippe VOET, Deinze (BE)

(73) Assignee: ETIVOET BV, Deinze (BE)

(21) Appl. No.: 18/874,617

(22) PCT Filed: Jun. 22, 2023
(86) PCT No.: PCT/EP2023/067032

§ 371 Date: Dec. 13, 2024

(30) Foreign Application Priority Data
Jun. 23, 2022 (BE) BE2022/5498

(51) Int. Cl. G09F 3/02; G09F 3/10

(52) U.S. Cl. CPC G09F 3/02; G09F 3/10; G09F 2003/0242; G09F 2003/0245; G09F 2003/0272

(57) ABSTRACT

The current invention relates to a label comprising a front (4) and a rear side (6) wherein said front side (4) is provided with information and a rear side is provided with an adhesive layer (3) for bonding said label on an article (1), such as packaging, and wherein a spacing agent (2) is arranged above said adhesive layer, such that a discontinuous pattern is formed over said adhesive layer, thereby shielding portions of said adhesive layer by said spacing agents, whereas other portions are not shielded, characterized in that, said spacing agent has a thickness of between 0.5 and 200 microns.

### FIELD OF THE INVENTION

The present invention relates to a washable label for reusable and recyclable consumption packaging.

### BACKGROUND

Labels are universal information carriers encountered on products, such as food and beverages. Labels can be used to show product information on the outside of a package. Moreover, the label ensures that the product can be recognized and often is representative of a brand. In general, labels are fixed on packaging with adhesives.

Used packaging may end either in a landfill or be recycled or reused. However, due to the hazardous environmental implications of landfills, there is a pressure on shift to predominantly recycling or reuse of packaging at the end of life. Both recycling and reuse require the removal of the labels before cleaning/recycling.

Packaging may be reused or recycled when it is manufactured of glass, aluminum, steel, paper or plastics.

Plastic bases packaging may be mechanically or chemically recycled. Plastic food packaging is almost exclusively recycled by mechanical processes that include collecting, sorting, washing, and grinding of the material. Since the product is not sufficiently clean for food contact at this stage, more decontamination steps are necessary, e.g., high-temperature, vacuum, or inert gas treatments, before it can be remelted and reformed. Used to a lesser extent, chemical recycling involves breaking down plastic polymers into smaller molecules for reuse in new syntheses.

Paper-based packaging may also be recycled into new paper and board. The steps of paper recycling include pulping, removal of non-fibrous parts, cleaning and, optionally, bleaching and de-inking steps. It is always necessary to mix with fresh fibers to maintain the quality before processing the pulp on a paper (board) machine.

Food and beverage packaging made of aluminum consists of alloys of >90% aluminum with other metals, such as copper, zinc, and manganese. Steel cans are produced from tin-coated steel, also called tinplate, or electrolytic chromium coated steel. Before recycling, aluminum cans are shredded, and the lacquers and coatings are removed by heating. Then the material is melted in a furnace at 750° C. and cast into ingots that are later rolled into sheets to produce parts that form new aluminum cans. Ideally, the composition of the aluminum alloy is controlled and adjusted during recycling to avoid the accumulation of unwanted metals. Steel cans are easily separated from other waste due to their magnetic properties. Then they are cleaned of grease and nonmetallic materials (e.g., paper labels) and undergo a detinning process removing the internal layer of tin. Virgin molten iron is added to the detinned steel in a furnace at up to 2000° C. Impurities are removed by blowing high-purity oxygen into the metal. The recycled steel is then cast into solid slabs, rolled into coils and ready to be used for new steel cans.

Glass recycling is an energy-intensive process, as the glass is melted at temperatures above 1500° C. However, compared to the production of virgin glass, the process saves up to 25% of energy. Depending on the color, different amounts of virgin glass need to be added during recycling: green, brown, and white glass can be recycled from up to 100%, 70%, and 60% glass cullet of the respective color. Glass can be repeatedly recycled without loss of quality.

When treated carefully, glass is very durable and stable. These properties make glass very suitable for reuse. In some circumstances, packaging made of plastic, paper, metal or any other material may as well be reusable. In the beverage industry, glass containers are cleaned and reused. With each return before refilling, the labels are detached during the washing of the vessels. Then the vessels are refilled and relabeled corresponding to the beverage type filled. Often, paper labels with wet-glue adhesive are used for the labeling of reusable containers. In this case, the wet-glue adhesive is applied to the full surface or in strips, the adhesive only being applied to the paper immediately before labeling. The disadvantage of this label type is that the filler must work with wet glue and the handling of these labels is often difficult. Moreover, complete removal of the label and glue is often unattainable and residues remain bound to the reusable packaging.

There is a need for an alternative way of applying a label to reusable packaging enabling a rapid and effortless washing-off of the label from the packaging without residual adhesive being left behind on the reusable packaging.

The present invention intends to find a solution to at least some of the above-mentioned problems.

### SUMMARY OF THE INVENTION

The present invention and embodiments thereof serve to provide a solution to one or more of the above-mentioned disadvantages. To this end, the present invention relates to a washable label, comprising on the rear side an adhesive layer shielded by a spacing agent according to claim 1.

Preferred embodiments of the label are disclosed in embodiments 2 to 10.

In a second aspect, the present invention relates to an article that is labeled with a washable label according to claim 11. More particularly said article may be a reusable or recyclable packaging but also any other object.

In a third aspect, the present invention relates to a method for producing a washable label, according to claim 12.

In a fourth aspect, the present invention relates to the use of a washable label for labelling an article, according to claim 13.

In a final aspect, the present invention relates to a method of removing a washable label, according to claims 14 and 15.

### DESCRIPTION OF FIGURES

FIG. 1 shows a cross-section of the component layers of a label, according to an embodiment of the current invention.

### DETAILED DESCRIPTION OF THE INVENTION

The present invention concerns a new way of applying a label to reusable packaging wherein said label is washable from said packaging.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g., component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

The term “can be washed off” as used herein refers to the separation of a label, initially adhered to a reusable consumption packaging by means of an adhesive, from a reusable packaging by bringing the label and the packaging it is attached to in contact with an aqueous solution. In some instances, the separation occurs at elevated temperatures. Additives may be used in the aqueous solution to facilitate the washing-off process.

The term “hydrophilic” as disclosed herein denotes a molecule or other molecular entity that is attracted to water molecules and tends to be dissolved by water.

The term “hydrophobic” as disclosed herein denotes a molecule or other molecular entity that are not attracted to water molecules and repelled by water.

“Hydroneutral” molecules are those molecules with hydrophilicities intermediate between those of hydrophilic and hydrophobic molecules.

A “web or film material” as used in the present disclosure, is a continuous roll of a flexible material such as paper or thin-layered polymers that is in the process of being formed, converted, or printed into a label. The web or film material can either be cut down into sheets during the manufacturing process or sent to converters or printers in roll form.

The term “weakening” or “weakens” as used herein, refers to the effect of water on the adhesion power of the adhesive layer. Upon contact with water, the adhesive layer slowly loses its adhesion property.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may refer to different embodiments. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the present disclosure relates to a label comprising a front and a rear side wherein said front side is provided with information and said rear side is provided with an adhesive layer for bonding said label on an article, such as packaging, and wherein a spacing agent is arranged above said adhesive layer, such that a discontinuous pattern is formed over said adhesive layer, thereby shielding portions of said adhesive layer by said spacing agent, whereas other portions of said adhesive layer are not shielded. In a preferred embodiment, said spacing agent has a thickness of between 0.5 and 200 microns.

The label as disclosed herein can be easily washed off without leaving residues of the label and/or the adhesive on the packaging. The spacing agent is arranged on the adhesive layer and shields portions of said adhesive layer from adhering to the article. This creates air pockets between the adhesive and the article to which said label adheres. During the cleaning process, water circulates through these air pockets where the label did not adhere to the packaging, and weakens the adhesion power of said adhesive, in a faster and more efficient manner. In the cleaning process of conventionally glued labels, the lack of space between the label and packaging causes the label to tightly adhere and the adhesive is inaccessible to the washing water.

It was surprisingly found that not only the discontinuous pattern contributes to the washability of the label, but also the thickness of the spacing agent. Indeed, the thickness of the spacing agent influences the degree of adhesion of the adhesive. If the spacing agent is very thin, the adhesion between the label and packaging is too strong and it cannot be broken efficiently upon washing. On the other hand, if the spacing agent is very thick, the label does not adhere properly to the packaging. The inventors determined that the spacing agent should have a thickness of between 0.5 and 200 microns in order to ensure that the label properly adheres to the surface but at the same time, upon washing, the adhesive is efficiently weakened and said label washes off.

In a preferred embodiment, the label is provided with a spacing agent arranged on the adhesive layer and shielding portions of said adhesive layer from adhering to the article. The spacing agent neutralizes thus the adhesive action of the adhesive relative to the article on the portions where it is present. Under conditions in which the label should keep its adhesion to the article, which include normal ambient temperatures, cold storage, and deep-freeze storage, the neutralizing action of the spacing agent is seamless. However, providing a spacing agent ensures an efficient removal of the label during the washing-off process. When the spacing is present, the adhesive has a more limited adhesive action relative to the article than it would have in the absence of said spacing agent.

In an embodiment of the label as disclosed herein, the spacing agent has a thickness of between 0.5 and 200 microns. Preferably, said agent thickness is between 0.5 and 200 microns, between 0.5 and 180 microns, between 0.5 and 160 microns, between 0.5 and 140 microns, between 0.5 and 120 microns, between 0.5 and 100 microns, between 0.5 and 95 microns, between 0.5 and 90 microns, between 0.5 and 85 microns, between 0.5 and 80 microns, between 0.5 and 75 microns, between 0.5 and 70 microns, between 0.5 and 65 microns, between 0.5 and 60 microns, between 0.5 and 55 microns, between 0.5 and 50 microns, between 0.5 and 45 microns, between 0.5 and 40 microns, between 0.5 and 35 microns, between 0.5 and 30 microns, between 0.5 and 25 microns, between 0.5 and 20 microns, between 0.5 and 19 microns, between 0.5 and 18 microns, between 0.5 and 17 microns, between 0.5 and 16 microns, between 0.5 and 15 microns, between 0.5 and 14 microns, between 0.5 and 13 microns, between 0.5 and 12 microns, between 0.5 and 12 microns, between 0.5 and 11 microns, between 0.5 and 10 microns, between 0.5 and 9 microns, between 0.5 and 8 microns, between 0.5 and 7 microns, between 0.5 and 6 microns, between 0.5 and 5 microns, between 0.5 and 4 microns, between 0.5 and 3 microns, between 0.5 and 2 micron, between 0.5 and 1 microns, or more preferably between 1 and 140 micron.

In an alternative embodiment, the spacing agent has a preferred thickness of between 1 and 200 microns, between 2 and 200 microns, between 3 and 200 microns, between 4 and 200 microns, between 5 and 200 microns, between 6 and 200 microns, between 7 and 200 microns, between 8 and 200 microns, between 9 and 200 microns, between 10 and 200 microns, between 11 and 200 microns, between 12 and 200 microns, between 13 and 200 microns, between 14 and 200 microns, between 15 and 200 microns, between 16 and 200 microns, between 17 and 200 microns, between 18 and 200 microns, between 19 and 200 microns, between 20 and 200 microns, between 25 and 200 microns, between 30 and 200 microns, between 35 and 200 microns, between 40 and 200 microns, between 45 and 200 microns, between 50 and 200 microns, between 55 and 200 microns, between 60 and 200 microns, between 65 and 200 microns, between 70 and 200 microns, between 75 and 200 microns, between 80 and 200 microns, between 85 and 200 microns, between 90 and 200 microns, between 95 and 200 microns, between 100 and 200 microns, between 120 and 200 microns, between 140 and 200 microns, between 160 and 200 microns, or between 180 and 200 microns.

In a preferred embodiment of the label, the spacing agent is a liquid or a semi-liquid, such as a varnish. Any type of varnish known in the art may be used as a spacing agent. Without wishing to be bound to theory, the main types of varnish widely used are solvent-based varnishes, water-based varnishes and radiation-cured varnishes.

Solvent-based varnishes are a combination of drying oils, resins and/or thinners or solvents. Any drying oil, resin and/or solvent known in the art as being suitable for use in varnish may be used in the spacing agent of the present disclosure. Non-limitative examples of drying oil include linseed oil, tung oil and walnut oil. Any natural resin including amber, kauri, gum, dammar, copal, rosin (colophony or pine resin), sandarac, balsam, elemi, mastic, and shellac or synthetics such as acrylic, alkyd, polyurethane, phenolic, vinyl, epoxy or silicone may be used in the spacing agent disclosed herein. Non-limitative examples of solvents that might be used in the spacing agent as disclosed herein include alcohols, petroleum distillates such as white spirit, paint thinner or mineral spirit.

Water-based varnishes comprise water-soluble resins. Non-limiting examples of water-soluble resins include acrylic, vinylformic acid, epoxy, urethane, alkyd, polyester, polyurethane, latex and derivatives thereof.

An epoxy resin system generally consists of a curing agent and an epoxy resin. Both the curing agent and the epoxy resin can be made waterborne. Solid epoxy resin (molecular weight >1000) dispersions are available and consist of an epoxy resin dispersed in water sometimes with the aid of co-solvents and surfactants. The resin backbone is often modified to ensure water dispersibility. These resins dry in their own right by water/co-solvent evaporation and the particles coalescence. To cure the resin and crosslink it, an amine-based curing agent is usually added. This produces a two-component system. An alternative is to use standard medium viscosity liquid epoxy resins and emulsify them in a water-soluble polyamine or polyaminoamide hardener resin which also gives a two-component system.

Water reducible alkyds are conventional alkyd resins such as polyesters based on saturated or unsaturated oils or fatty acids, polybasic acids and alcohols, modified to confer water miscibility. Typical components are vegetable oils or fatty acids such as linseed, soyabean, castor, dehydrated castor, safflower, tung, coconut and tall oil. Acids include isophthalic, terephthalic, adipic, benzoic, succinic acids and phthalic, maleic and trimellitic anhydride. Polyols include glycerol, pentaerythritol, Trimethylolpropane, ethylene glycol, propylene glycol, diethylene glycol, neopentyl glycol, 1,6-hexanediol and 1,4-butanediol.

Saturated polyester resins contain many of the materials used in conventional alkyd resins but without the oil or fatty acid components. Typical components for these resins are poly carboxylic and polyhydroxyl components. The more commonly used polyacids are phthalic, isophthalic, terephthalic and adipic acid. Phthalic and trimellitic anhydrides may also be used. Polyols tend to be neopentyl glycol, 1,6-hexanediol and trimethylolpropane. To make them waterborne organic acids or anhydrides are added in a two-stage process but there are other methods too.

Polyurethanes resins are available waterborne. The single-component versions are usually referred to as polyurethane dispersions. They are available in anionic, cationic and nonionic versions. The use of an anionic or cationic center or a hydrophilic non-ionic manufacturing technique tends to result in a permanent inbuilt water resistance weakness.

Waterborne polyurethanes are also available in 2 component versions consisting of polyol(s) and an isocyanate and isocyanates react with water this requires special formulating and production techniques.

Water-based varnishes do not require the use of solvents and thus eliminate some of the problems associated with the use of solvents, such as reduced flammability and reduction of solvent vapor discharge into the atmosphere that has environmental implications.

Radiation-cured varnishes utilize polymerizable monomers and/or oligomers such as, but not limited to methacrylates comprising no fluorine and silicon, that polymerize in the presence of radiation, such as for example UV radiation. Curing by UV radiation basically consists of photoinitiating the polymerization of multifunctional monomers and polymers, which are transformed into a three-dimensional structure. Photoinitiators convert light energy into chemical energy, forming free radicals or cations. UV-cured vanishes give more protection and sheen than solvent- or water-based varnishes and, since it is cured with light and not heat, no solvents are emitted.

In another embodiment of the label, the spacing agent is a physical object, such as a mesh structure. In some embodiments, the spacing agent is made of polypropylene (PP), bio-PP, polyethylene (PE), polylactic (PLA), polyolefin, nylon, polyvinyl chloride (PVC), polytetrafluoroethylene (PTFE), metal, textile, fiberglass or silicone. In a preferred embodiment, the spacing agent is made of PP. It will be obvious for a skilled person that any material capable to take an object form or form a mesh structure, may be used as a spacing agent. A mesh may be extruded, oriented, expanded, woven, tubular or knitted.

The spacing agent as disclosed herein may have any degree of hydrophilicity. It may be hydroneutral, hydrophilic, hydrophobic or strong hydrophobic. Adhesive coating agents known in the art are hydrophilic. When washing off a label from an article, the hydrophilic coating present will attract water molecules and therefore augment the migration of water molecules towards the adhesive. As a result, an aqueous solution at elevated temperatures is able to reach the adhesive more effectively, as a result of which the aqueous solution can be employed more effectively for undoing the adhesive action of the adhesive. The present invention eliminates the need for a hydrophilic coating agent by using a spacing agent that forms pockets of air. As a result, the water circulates through the channels formed by said pockets of air and accessed the adhesive dissolving it.

In non-limiting embodiments, the spacing agent may be thermo-setting or UV-setting.

The spacing agent may be applied to the adhesive layer by any means suitable for providing a physical object or a mesh to an adhesive layer. The varnish may be sprayed, coated or casted on said adhesive layer. The mesh may be waved, welded or 3-D printed and placed afterward on said adhesive layer.

In an embodiment, the spacing agent is provided in a discontinuous pattern consisting preferably of a dotted pattern, line pattern, geometric figure, and/or a random pattern. The term ‘discontinuous pattern’ refers to a layer or object that is not continuous and, as a result, comprises one or more interspaces or openings, comprised in a pattern (that may or may not be a geometric, symmetric or any random pattern).

In a preferred embodiment, the discontinuous pattern of the spacing agent consists of a line pattern. Said line pattern may be a continuous line, a dotted line or an interrupted line. In a line pattern, the interspaces or openings are at least partially bounded by continuous lines. Preferably, said continuous lines have been organized in a grid, wherein at least one continuous line is oriented in a different direction than another continuous line, and the differently oriented continuous lines intersect. The difference in orientation may correspond with any angle. The continuous lines may be straight or may show any or a specific curved form. Applying the spacing agent in continuous lines has the advantage that each continuous line can be applied in one uninterrupted motion.

In another embodiment, the discontinuous pattern of the spacing agent consists of a plurality of geometric figures. Any geometric figure is possible, including circles, squares, rectangles, triangles, polygonal structures, irregular structures and slit-shaped structures.

Providing the spacing agent in a discontinuous pattern is a way of allowing an adequate adhesion between the label and the article under conditions of storage and/or use. Providing the spacing agent on the adhesive in a discontinuous pattern ensures that there are certain zones of the adhesive that have been coated, whereas other zones of the adhesive have not. The zones of the adhesive that have not been coated may under conditions of storage and/or use still affect adequate adhesion between the label and the article. It may, for example, be of importance that the uncoated zones of the adhesive are sufficiently large. The adhesive action of the adhesive relative to the article is neutralized at the level of the zones of the adhesive that have been provided with a spacing agent. Due to said neutralization of the adhesive action of the adhesive, providing a spacing agent in a discontinuous pattern on the adhesive will, as a result, facilitate removing the label from the article, when contacted with an aqueous solution at an elevated temperature. In addition, the interspaces or openings in the discontinuous pattern of the spacing agent provide channels, which channels are able to transport an aqueous solution at elevated temperatures rapidly through the interface between the label and the article, which is advantageous for washing off said label.

In an embodiment of the label as disclosed herein, at least 10% of the adhesive layer is shielded by said spacing agent. In other embodiments, at least 10%, 15%, 20%, 25%, 30%, 35%, 40%, 45%, 50%, 55%, 60%, 65%, 70%, 75%, 80%, 85% or 90% of the adhesive layer is shielded by the spacing agent.

The front side of the label preferably contains information such as an indication, a brand, and/or a composition of the content of the packaging. An indication may, for instance, refer to an expiration date or to any decorative element. An indication may additionally also be formed by providing the front side of the information carrier with a specific colour, wherein optionally a specific meaning can be attached to such a colour. In an alternative embodiment, no information or colour is placed on the front side of the information carrier. The rear side of the label is coated with an adhesive. The adhesive serves as an intermediate medium that adheres a label and a packaging to each other.

In an embodiment of the label, the rear side of said label is provided with an adhesive or is covered in an adhesive, such as a glue, to such an extent that the label can adhere to a packaging.

Any adhesive thickness may be used with the label as disclosed herein.

In a further embodiment of the label, the adhesive is provided with a spacing agent in a coverage degree of at least 10%, and at the most 60%, preferably at the most 50%, wherein the coverage degree is expressed relative to the surface area of the label. Given that the adhesive is provided with the spacing agent in a discontinuous pattern, the coverage degree is defined by the size, shape, number and density of the interspaces or openings in the discontinuous pattern. A label that can easily wash off, as disclosed herein, has only parts of the surface area adherent to an article, and thus higher coverage degrees of the spacing agent are sought.

In a preferred embodiment, the label is comprised of a web or a film material. The term “film material” refers to thin-layered plastic polymers. Non-exclusive examples of plastics that may serve as film material for the label are polypropylene, polyethylene, polyvinyl chloride, polyolefins, polyesters, polystyrenes, biopolymers such as cellophane or polylactic acid (PLA), water-impermeable polyolefin, or biaxially-oriented polypropylene (BOPP). The polymer films may be a laminate or a single layer, in some embodiments. In other embodiments, the polymer film may include additional layers such as metalized layers. The polymer film may be transparent to provide a “no-label” look is alternative embodiments. In yet other embodiments, the polymer film may or may not be colored to match the color of an article to which the label is to be attached. In preferred embodiments, the polymer film may have a thickness typical of films for labels, such as from 15 μm to 100 μm, preferably 40 to 50 μm. In another preferred embodiment, the film material has a grammage of 30 to 96 g/m2, measured according to ISO 536. The polymer film may be treated by known methods in the art and may be coated in a manner that is known per se.

Alternatively, the label is made of a web material, such as paper. In a preferred embodiment, the paper label has a grammage of 60 to 170 g/m², measured according to ISO 536.

In some embodiments, the label as disclosed herein comprises a backing layer. The backing layer is defined as a rear layer of a pressure-sensitive label in direct contact with the adhesive layer of said label. Such backing layers are invariably provided on labels with adhesive layers, to cover the adhesive during transport and handling so as to prevent the adhesive sticking unintentionally to itself or to other articles. The backing layer is removed just before the label is affixed to the intended article. The backing layer may be made of paper or polymeric film such as plastic, fabric, foil or any other material. The backing layer may be provided with a peel-off cover layer to ensure that the label can easily be removed from the backing layer and that the adhesive remains adhered to the label after said removal.

In alternative embodiments, the label has no backing layer. In some instances, a silicone layer is applied on the front side of the label. When said label is rolled, for storage, transport, etc., the adhesive layer of the rear side of the label comes in contact with the silicone layer of the front side. This abolishes the need for a backing.

In a second aspect, the present disclosure relates to an article having a label as described in any of the previous embodiments. In a preferred embodiment, said article is a consumption packaging, preferably a reusable packaging. Any reusable or recyclable packaging known in the art may be labeled with the label disclosed herein. Non-limiting examples include reusable packaging made of glass, plastic, metal or cardboard. In other embodiments, the label as disclosed herein may be applied on non-reusable consumption packaging or surfaces of other objects. A non-exclusive example of “another object” is a metal storage rack placed in a cold store as a supporting structure of, for example, reusable consumption packages and their content. Further examples of “other objects” are furniture items, stationary objects, cooking utensils and appliances, electronic devices, toys, window glass, sport equipment and house renovation materials such as floorboards or sanitary objects but are not limited to these. These articles may be of domestic or industrial use, and may be made of wood, metal, glass, ceramic, stone, plaster, cement, concrete, composite materials, plastics, etc.

In a third aspect, the invention relates to a method for producing a label comprising the following steps:
providing a web or a film material;
applying a layer of adhesive to the rear side of the web or film material;
providing a spacing agent layer in a discontinuous pattern onto the adhesive layer;
providing a printing on the front side of the web or film material;
punching labels in the web of film material;
wherein said spacing agent has a thickness of between 0.5 and 200 microns.

The method is suitable for producing labels that under conditions of storage and/or use, can be adhered and are able to remain adhered to articles, and in addition can be separated from said article by contact with an aqueous.

In some embodiments of the method, the label is removed by contact with water at elevated temperatures. In other embodiments, said label is removed by contact with cold water. The water temperature at which the label is removed successfully is dependent on the thickness of the adhesive layer and the coverage and/or pattern of the spacing agent. Labels with thick adhesive layers and/or thin spacing agent layers are removable only at elevated temperatures. Labels having thin adhesive layer and/or thick spacing agents are easier to remove and may be removed in contact with cold water.

In the first step of the method, a web or film material is provided. A ‘web or film material’ is defined as a web of material, suitable for making labels, extending in the longitudinal direction. The web or film material consists of a layer of paper or of a layer of film material. Non-exclusive examples of plastics that may serve as film material are polypropylene, polyethylene and polyvinyl chloride.

In a second step, a layer of adhesive is applied to one side of the web or film material. Preferably the adhesive layer has a limited thickness. The web or film material provided with an adhesive layer is applied onto a backing layer by means of the adhesive layer. The web or film material protected by the carrier can be subjected to a cleaning step, by means of an aqueous solution. In addition, the web or film material can be subjected to a corona treatment. Both the cleaning step and the corona treatment are, among other things, aimed at increasing the surface tension of the web or film material, thus enabling a better adhesion of ink to the latter. The label provided with an adhesive layer, applied to a backing, may be stored in rolls. Such rolls are then unwound for further treatment steps.

In a third step, a spacing agent is applied in a discontinuous pattern onto the adhesive layer. The discontinuous pattern may be a continuous or dotted line or any other pattern as described in previous embodiments. The spacing agent ensures that only a limited surface of the adhesive layer comes in contact with the article to which the label is applied.

In a fourth step, one side of the web or film material, opposite the side of the web or film material provided with an adhesive layer, is provided with a printing. The printing can be applied using various processes e.g., flexographic printing, gravure printing, screen printing, warm press printing, cold press printing, hot foil printing, cold foil printing, letterpress printing, rotogravure printing, offset printing and/or digital printing. Non-exclusive examples of digital printing techniques are ink jet printing and laser printing.

A fifth step of the method relates to punching labels in the web or film material. Preferably a template is used to punch the labels in the web or film material. After punching, the rest of the web or film material is removed, and the labels are wound into finished rolls. Said finished rolls can be understood to be cylindrical structures onto which desired quantities of labels, still applied to a backing by means of an adhesive layer, can be affixed. The use of this method will permit large-scale production of labels. An end-user will be able to separate labels from the backing layer from a finished roll, after which, by means of their adhesive layer the labels can be attached to articles, such as bottles of plastic or glass.

In a fourth aspect, the present disclosure relates to the use of a label according to any of the above-described embodiments, for labeling packaging. In preferred embodiments, the label may be used on reusable packaging. In other embodiments, the label is used on recyclable or non-recyclable packaging. In yet another embodiment the label may be used on any article that is suitable for being labelled.

The label is applied on said packaging or article with the rear side of said label, which is the side comprising the adhesive layer shielded by the spacing agent, in direct contact with the surface of the article and/or packaging. The spacing agent prevents the label to adhere to the surface of the package or article in some portions. This creates pockets between the adhesive and the article to which said label adheres. These air pockets ensure the access of water to the glue during the cleaning process.

When a backing layer is used for protecting the adhesive layer and supporting the label, said backing layer is delaminated from the label prior to the application of said label to a packaging or an article.

In an embodiment, the label is used in labeling packaging and articles in an automated way.

In a final aspect, the present disclosure relates to a method of removing a label as disclosed in any of the previous embodiments, from an article, wherein said article is submerged or sprayed and washed in water.

The presence of the spacing agent on the rear side of the label, in direct contact with the article, ensures an easy and effective detachment of the label from said article. The spacing agent creates air pockets or channels, through which washing water penetrates and weakens the adhesive, causing the label to be removed.

In some embodiments of the method, the article is submerged in water. In other embodiments, it is sufficient to spray said article with water, for the removal of the label.

In preferred embodiments of the invention the sole washing agent used for the removal of the label is water. In other embodiments, additives are added to the washing water. The additives are preferably selected from pH modifying agents, antifoaming agents, foaming agents, anticorrosion agents, preservatives, sequestrants, surfactants, water hardening agents, water softening agents, fragrances and/or other additives conventionally used in the field of detergents, and also the mixtures of two or more thereof in any proportion. The additives, such as detergents or surfactants are added to the washing water in order to lower the surface tension between the water and the mineral oils, fatty acids, esterified fatty acids, alcohols, silicones, organopolysiloxanes, poly(alkylene glycol) s, paraffins, waxes, microcrystalline waxes adhesive. Non-limiting examples of additives include NaOH, sorbitan esters, fatty amines, fatty amides, polyalkoxylated amines, polyalkoxylated amides, polyalkoxylated fatty amines, polyalkoxylated fatty amides, alkoxylated alcohols, alkoxylated alkyls and especially ethoxylated, propoxylated and/or butoxylated fatty alkyls and alcohols, glycol esters, glycerol esters, fatty acid triglycerides, fatty ester triglycerides, alkyl polyglycosides, phosphoric acid esters, alkoxylated alkylamines, betaines, amine oxides, and in particular amine oxides bearing a fatty alkyl chain, poly(alkylene oxide) s also known under the name polyoxyalkylene, where alkylene stands for ethylene, propylene or butylene, block copolymers of these poly(alkylene oxide) s, fatty alcohol alkoxylates, alkylphenol alkoxylates, fatty amine alkoxylates, fatty acid alkoxylates, carboxylates, in particular of fatty acids, alkyl sulfonates, alkylaryl sulfonates, alkyl sulfates, quaternary ammonium salts or quaternary ammonium salts of alkoxylated amines.

In some embodiments of the method, the temperature of the washing water is between 5° C. and 80° C., between 10° C. and 80° C., 15° C. and 80° C., 20° C. and 80° C., 30° C. and 80° C., 40° C. and 80° C., 50° C. and 80° C., 60° C. and 80° C. or 70° C. and 80° C. Alternatively, the temperature of the washing water is between 5° C. and 80° C., 5° C. and 70° C., 5° C. and 60° C., 5° C. and 50° C., 5° C. and 40° C., 5° C. and 30° C., 5° C. and 20° C., 5° C. and 15° C. or 5° C. and 10° C. The preferred temperature of the washing water is 80° C., 60° C. or 40° C. Due to the presence of the spacing agent and thus to the fact that not the entire surface of the label adheres to the article, the label can be removed by washing with cold, warm or hot water, making the present method highly versatile.

In an embodiment of the method, the article is washed between 5 and 30 minutes, preferably 15 minutes, more preferably 10 minutes in order to ensure the removal of the label.

In a further embodiment of the method, the label is detached from the article within 8 minutes after the start of the washing, preferably within 5 minutes, more preferably within 3 minutes. The time necessary for the label to be detached from the article is dependent on the temperature of the washing water and the coverage degree with the spacing agent. The higher the water temperature or the coverage degree, the faster the label gets detached.

In some embodiments of the method, the label is washed off manually. In preferred embodiments, the washing is automated in a washing machine. The design of the label ensures that the washing procedure does not require scraping but the label comes off by itself in contact with the water.

In a preferred embodiment, upon removal of said label, the adhesive layer and the spacing agent remain on the label. No residues of label, adhesive and/or spacing agent remain on the package and in the washing water. This minimizes the amount of contaminants remaining inside the washing machine.

It is also preferable that the washing process of the adhesive is not substantially complicated due to its aging during the shelf life of the product. Usually, this period reaches 24 months, counting from the moment of labeling, and for this period the temperature, humidity and UV radiation, which change in time, affect the labeled container.

The inventors have surprisingly observed that due to the thickness of the spacing agent, when an article comprising a label according to the invention is submerged in water, the liquid runs along the edges and penetrates through the network of air pockets formed by the spacing agent. The warm water gets thus in contact with the adhesive and said water slowly weakens said adhesive. By the end of the washing cycle, the glue is completely wore off and the label washes of said article.

However, it is obvious that the invention is not limited to this application. The use of a spacing agent between an adhesive layer and an article may be applied to any objects and/or layers that adhere to one another and require deadhesion.

The invention is further described by the following non-limiting examples which further illustrate the invention, and are not intended to, nor should they be interpreted to, limit the scope of the invention.

### Examples

An experiment was performed to determine the washing-off potential of labels provided with various spacing agents. Paper labels of 80 mm×180 mm were provided with a continuous layer of glue. The glue layer was provided with two types of spacing agents, varnish and mesh. Three tests were run for each type of spacing agent (varnish and mesh). Each varnish test was performed with a different varnish type: hydroneutral with 0% silicone acrylates, hydrophobic with 1% silicone acrylates and hydrophobic with 10% silicone acrylates. Each varnish type was applied in 10 different thickness layers (0.3 μm, 0.5 μm, 1 μm, 2 μm, 4 μm, 6 μm, 9 μm, 13 μm, 14 μm and 20 μm). The mesh tests were repeated three times, each time with the same mesh type. The meshes were applied in 9 different thickness layers (20 μm, 30 μm, 40 μm, 50 μm, 60 μm, 85 μm, 100 μm, 140 μm and 210 μm), and were made of PP or PE. Each label type was applied on a glass surface and subjected to a washing-off test, in a washing machine, at 80° C. for 15 minutes. The washing liquid contained water only. All tests were performed in three repetitions.

TABLE 1
Type of spacing agents tested and results
obtained after 15 minutes of washing.

| | | Test 1 - | Test 2 - | Test 3 - |
|---|---|---|---|---|
| Type of | | Hydroneutral | Hydrofobic 1 | Hydriphobic 2 |
| spacing | Thickness of | (0% silicone | (3% of silicone | (10% silicone |
| agent | spacing agent | acrylates | acrylates) | acrylates) |
| Varnish | 0.3 | Label not | Label not | Label not |
| | | removed | removed | removed |
| | 0.5 | OK | OK | OK |
| | 1 | OK | OK | OK |
| | 2 | OK | OK | OK |
| | 4 | OK | OK | OK |
| | 6 | OK | OK | OK |
| | 9 | OK | OK | OK |
| | 13 | OK | OK | OK |
| | 14 | OK | OK | OK |
| | 20 | OK | OK | OK |

| Type of | Thickness/ | | | | |
|---|---|---|---|---|---|
| spacing | material of | | | | |
| agent | spacing agent | | Test 1 | Test 2 | Test 3 |
| PP mesh | 30 | PP | OK | OK | OK |
| | 40 | PP | OK | OK | OK |
| | 50 | PP | OK | OK | OK |
| | 60 | PP | OK | OK | OK |
| | 85 | PE | OK | OK | OK |
| | 100 | PP | OK | OK | OK |
| | 140 | PP | OK | OK | OK |
| | 210 | PP | Label did | Label did | Label did |
| | | | not bond | not bond | not bond |
| | | | sufficiently | sufficiently | sufficiently |

The labels with all three types of varnish, applied at 0.3 μm thickness were not completely removed from the glass. In all three tests, the PP mesh at 210 μm thickness caused the label to not bond sufficiently to the glass support. The labels that had spacing agents with thicknesses between 0.5 μm and 140 μm stuck sufficiently to the glass (Table 1) at normal ambient temperature and humidity and were completely removed from the glass surface after 15 minutes of washing without leaving any residue on the surface of the glass.

### DESCRIPTION OF FIGURES

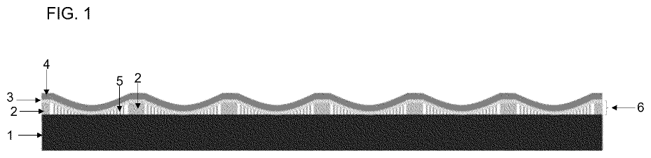

With reference to FIG. 1, a cross-section of the component layers of a label, according to an embodiment of the current invention, is shown. Said label has a front side (4) made of paper a web material such as paper or thin-layered polymers on which information is printed, and a rear side (6). The rear side (6) is provided with an adhesive layer (3) that bonds said label to an article (1). The article is a reusable or recyclable packaging in preferred embodiments

The adhesive layer (3) is provided with a spacing agent (2) that shields some portions of the adhesive layer (3) from bonding to the article (1). Said spacing agent (2) is applied in a discontinuous pattern and has a thickness of between 0.5 and 200 micron. Air pockets (5) are created by the spacing agent (2), between the adhesive layer (3) and the article (1). These air pockets (5) allow water to penetrate and weaken the adhesive causing the label to wash off. In preferred embodiments of the label as disclosed herein, the spacing agent is a varnish or a physical object such as a mesh.

### LIST OF INDICATED ELEMENTS

1 an article on which the label is bonded to
2 a spacing agent
3 ana adhesive layer
4 the front side of the label
5 air pockets
6 the rear side of the label

1. A label comprising a front and a rear side wherein said front side is provided with information and a rear side is provided with an adhesive layer for bonding said label on an article, such as packaging, and wherein a spacing agent is arranged above said adhesive layer, such that a discontinuous pattern is formed over said adhesive layer, thereby shielding portions of said adhesive layer by said spacing agents, whereas other portions are not shielded, characterized in that, said spacing agent has a thickness of between 0.5 and 200 microns.

2. The label according to claim 1, wherein the spacing agent creates air pockets between the adhesive and the article to which said label adheres.

3. The label according to claim 1, wherein the spacing agent is a liquid or a semi-liquid, such as a varnish.

4. The label according to claim 1, wherein the spacing agent is a physical object, such as a mesh structure.

5. The label according to claim 1, wherein at least 10% of the adhesive layer is shielded by said spacing agent.

6. The label according to claim 1, wherein the discontinuous pattern consists of a dotted pattern, line pattern, geometric figure, and/or a random pattern.

7. The label according to claim 1, wherein the adhesive is provided with a spacing agent in a coverage degree of at least 10%, and at the most 60%, preferably at the most 50%, wherein the coverage degree is expressed relative to the surface area of the label.

8. The label according to claim 1, wherein the label is comprised of a web or a film material.

9. The label according to claim 1, wherein said label comprises a backing layer or is a label without backing layer.

10. The label according to claim 1, wherein said label washes off at a temperature between 5 and 80° C.

11. The label according to claim 1, wherein the label is configured for an article.

12. A method for producing a label comprising the following steps:
providing a web or a film material;
applying a layer of adhesive to the rear side of the web or film material;
providing a spacing agent layer in a discontinuous pattern onto the glue layer;
providing a printing on the front side of the web or film material;
punching labels in the web of film material;
characterized in that, said spacing agent has a thickness of between 0.5 and 200 microns.

13. The label according to claim 1, wherein the label is configured according to claim 1 for labeling packaging.

14. A method of removing a label according to claim 1 from an article, wherein said article is submerged or sprayed and washed in water.

15. The method of claim 14 wherein the temperature of washing is between 5° C. and 80° C.
